(19) United States
(12) Patent Application Publication
(10) Pub. No.: US 2019/0311443 A1
(43) Pub. Date: Oct. 10, 2019

(54) METHODS, SYSTEMS, APPARATUSES AND DEVICES FOR FACILITATING PROVISIONING OF AUDIT DATA RELATED TO ENERGY CONSUMPTION, WATER CONSUMPTION, WATER QUALITY, GREENHOUSE GAS EMISSIONS, AND AIR EMISSIONS USING BLOCKCHAIN

(71) Applicant: Russell Blades, Charlotte, NC (US)

(72) Inventor: Russell Blades, Charlotte, NC (US)

(21) Appl. No.: 16/376,124

(22) Filed: Apr. 5, 2019

Related U.S. Application Data
(60) Provisional application No. 62/653,271, filed on Apr. 5, 2018.

(51) Int. Cl. G06Q 50/06; G06Q 40/00; G01D 4/00

(52) U.S. Cl. CPC G06Q 50/06; G06F 21/78; G01D 4/002; G06Q 40/12

(57) ABSTRACT

Disclosed herein is a method of facilitating provisioning of audit data related to energy consumption, water consumption, water quality, greenhouse gas emissions, and air emissions using blockchain, in accordance with some embodiments. Accordingly, the method may include receiving, using a communication device, a sensory data from at least one measuring device. Further, the method may include analyzing, using a processing device, the sensory data. Further, the method may include generating, using the processing device, the audit data based on the analyzing. Further, the audit data may include at least one of an energy usage data, a carbon emission data, a water usage data, an air emissions data, and a water quality data. Further, the method may include storing, using a storage device, the audit data on blockchain. Further, the audit data may be used for at least one of monitoring purposes, reporting purposes, and analytical purposes.

The current application claims a priority to the U.S. Provisional Patent application Ser. No. 62/653,271 filed on Apr. 5, 2018.

### TECHNICAL FIELD

Generally, the present disclosure relates to the field of data processing. More specifically, the present disclosure relates to methods, systems, apparatuses and devices for facilitating provisioning of audit data related to energy and water consumption and environmental emissions (GHG, NOx, SOx, Water Quality, etc.) using blockchain and then using the audit data for monitoring, reporting and analytical purposes.

### BACKGROUND

In the past, most publicly traded companies, cities and other businesses reported their GHG's and other (air, water) emissions/quality to governments (EPA, Federal, State, etc.), other third parties (Carbon Disclosure Project—CDP, Dow Jones Sustainability Index—DJSI, etc.), shareholders and the public.

However, today new standards that are being set or proposed by governments and the financial community (Task Force on Climate Related Financial Disclosure) will increase the need for climate change, GHG emissions and water consumption reporting to be much more transparent, accessible, accurate, auditable, timely and standardized. Similar requirements are also being proposed or implemented for environmental reporting of air emissions and water quality.

Unfortunately, today most companies and other energy users who report their GHG emissions, carbon footprint, water usage or air emissions or water quality do not have the proper systems, protocols, methodologies, assurance or technology in place to meet these more stringent reporting requirements. Today's methods for capturing and reporting GHG's and other emission data is also very manual; thus, requiring many internal and external resources and increasing the potential for inaccuracies and mistakes.

Therefore, there is a need for improved methods, systems, apparatuses and devices for facilitating provisioning of audit data related to energy and water consumption, GHG's and air and water reporting using blockchain that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating provisioning of audit data related to energy consumption, water consumption, water quality, greenhouse gas emissions, and air emissions using blockchain, in accordance with some embodiments. Accordingly, the method may include receiving, using a communication device, a sensory data from at least one measuring device. Further, the method may include analyzing, using a processing device, the sensory data. Further, the method may include generating, using the processing device, the audit data based on the analyzing. Further, the audit data may include at least one of an energy usage data, a carbon emission data, a water usage data, an air emissions data, and a water quality data. Further, the method may include storing, using a storage device, the audit data on blockchain. Further, the audit data may be used for at least one of monitoring purposes, reporting purposes, and analytical purposes.

Further disclosed herein is a system of facilitating provisioning of audit data related to energy consumption, water consumption, water quality, greenhouse gas emissions, and air emissions using blockchain, in accordance with some embodiments. Accordingly, the system may include a communication device configured for receiving a sensory data from at least one measuring device. Further, the system may include a processing device configured for analyzing the sensory data. Further, the processing device may be configured for generating the audit data based on the analyzing. Further, the audit data comprises at least one of an energy usage data, a carbon emission data, a water usage data, an air emissions data, and a water quality data. Further, the system may include a storage device configured for storing the audit data on blockchain. Further, the audit data is used for at least one of monitoring purposes, reporting purposes, and analytical purposes.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a system of facilitating provisioning of audit data related to energy consumption, water consumption, water quality, greenhouse gas emissions, and air emissions using blockchain, in accordance with some embodiments.

FIG. 3 is a flowchart of a method of facilitating provisioning of audit data related to energy consumption, water consumption, water quality, greenhouse gas emissions, and air emissions using blockchain, in accordance with some embodiments.

FIG. 4 is a flowchart of a method to facilitate accessing the audit data, in accordance with some embodiments.

FIG. 5 is a flowchart of a method to facilitate determining tampering associated with the at least one measuring device, in accordance with some embodiments.

FIG. 6 is a flowchart of a method to facilitate providing an audit data based on greenhouse gas GHG emission by an energy consuming entity to user devices, in accordance with some embodiments.

FIG. 7 is a flowchart of a method to facilitate an audit data to user devices whilst monitoring tampering of a meter, in accordance with some embodiments.

FIG. 8 is a flowchart of a method to facilitate carbon emission data and associated location to user devices, in accordance with some embodiments.

FIG. 9 is an exemplary representation of a network to facilitate an audit data for public disclosure based upon energy and equivalent GHG emissions data of energy and water consuming entities.

FIG. 10 is an exemplary method for obtaining calculations for the GHG emission and energy calculation, in accordance with some embodiments.

FIG. 11 is an exemplary method for obtaining calculations for the GHG emission and energy calculation, in accordance with some embodiments.

FIG. 12 is an exemplary representation of a system to facilitate provisioning audit data related to energy and water consumption using blockchain, in accordance with some embodiments.

FIG. 13 is an exemplary representation of energy flow from a power plant to a client load, in accordance with some embodiments.

FIG. 14 is an exemplary representation of fluid flow from one end of a fuel tank to another, in accordance with some embodiments.

FIG. 15 is an exemplary representation of a system to facilitate provisioning of audit data related to energy and water consumption using an alternative to blockchain, in accordance with some embodiments.

FIG. 16 is an exemplary multimedia content, in accordance with some embodiments.

FIG. 17 is an exemplary multimedia content, in accordance with some embodiments.

FIG. 18 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of provisioning of audit data related to energy consumption using blockchain, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a quantum computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure includes a system and a method to facilitate provisioning of audit data related to energy and water consumption and GHG emissions using blockchain. Further, the present disclosure may generally relate to Blockchain technology. Specifically, the present disclosure may relate to adapting Blockchain technology for computer and metering implemented frameworks and methods configured to locate, measure, validate, calculate, tag, protect, assign, digitally sign, detect tampering and meter downtime and manage energy information directly from billing and sub-meters that may be stored securely on a blockchain; which may provide the equivalent Energy Usage (GJ, etc.) and equivalent Greenhouse Gas Emissions (tonnes of CO2e, etc.) from these various energy sources (electricity, natural gas, propane, heavy fuel oil, diesel, etc.) and renewable sources (solar, wind, biomass, biofuels, geothermal, hydro, heat recovery, etc.) for reporting purposes. The present disclosure, in an instance, may provide a foundation for implementing an IT platform that facilitates the capture of accurate, timely and traceable Energy and Water Use and GHG emissions with verifiable provenance for carbon reporting purposes.

The background description includes information that may be useful in understanding the present invention. It is not an admission that any of the information provided herein is prior art or relevant to the presently claimed invention, or that any publication specifically or implicitly referenced is prior art.

In the past, most publicly traded companies, cities and other businesses reported their GHG's and other emissions to governments (EPA, Federal, State, etc.), other third parties (Carbon Disclosure Project—CDP, Dow Jones Sustainability Index—DJSI, etc.), shareholders and the public.

However, today new standards that are being set or proposed by governments and the financial community (Task Force on Climate Related Financial Disclosure) will increase the need for climate change, GHG and air emissions and water consumption and quality reporting to be much more transparent, accessible, accurate, auditable, timely and standardized. In other words, the same rigor and importance that companies place on their reported financial statements will be similarly applied to carbon and environmental reporting. Carbon emissions from Scope 1, 2 and 3 along with climate change risks will become part of a company's quarterly and annual filings, reporting and materiality tests. Unfortunately, today most companies and other energy users who report their GHG emissions and carbon footprint do not have the proper systems, protocols, methodologies, assurance or technology in place to meet these more stringent carbon reporting requirements. Today's methods for capturing and reporting GHG emission data is also very manual; thus, requiring many internal and external resources and increasing the potential for inaccuracies and mistakes.

In regard to GHG emissions, unless in-stack flue gas analyzers are in place to actually measure the GHG emissions (CO2, CH4, etc.) from the combustion of fuel or other processes (calcination, etc.), GHG's are estimated instead based on the type of fuel used, amount of fuel consumed and the percentage oxidation of the fuel. These conversion factors are available from various sources such as UNFCCC, IPCC, DEFRA, EPA, GHG Protocol, etc.

Further, most companies and others that report their energy usage and GHG emissions get their base information from the monthly energy billing data from utilities and other energy providers meter readings that are sent to the finance department. The finance department then manually enters the billing information (cost, consumption, dates, etc.) into their financial reporting system (Oracle, etc.) for each meter and site.

However, it's important to note that the energy bills from the energy providers (electric utility, diesel fuel supplier, etc.) do not provide the equivalent energy use (GJ, etc.) or the GHG emissions that are attributed to the energy consumed, so there is no standard energy usage or equivalent GHG data entered into the financial reporting system. Therefore, the equivalent energy use (GJ, etc.) and GHG emissions that result from say consuming 100,000 MWh (electricity) or 10,000,000 m³ of natural gas data that appears on the energy bills must be calculated by a qualified energy person on staff. These conversion calculations are usually made in an EXCEL or a similar spreadsheet software program. Some energy professionals use the Higher Heating Value of the fuels while others use the Lower Heating Value of the fuels to get the equivalent energy values (MWh, GJ, etc.) for reporting.

The energy values are then used with different GHG conversion factors from several sources (EPA, IPCC, etc.) by the various energy professionals to arrive at an equivalent GHG value for electricity and fuels consumed.

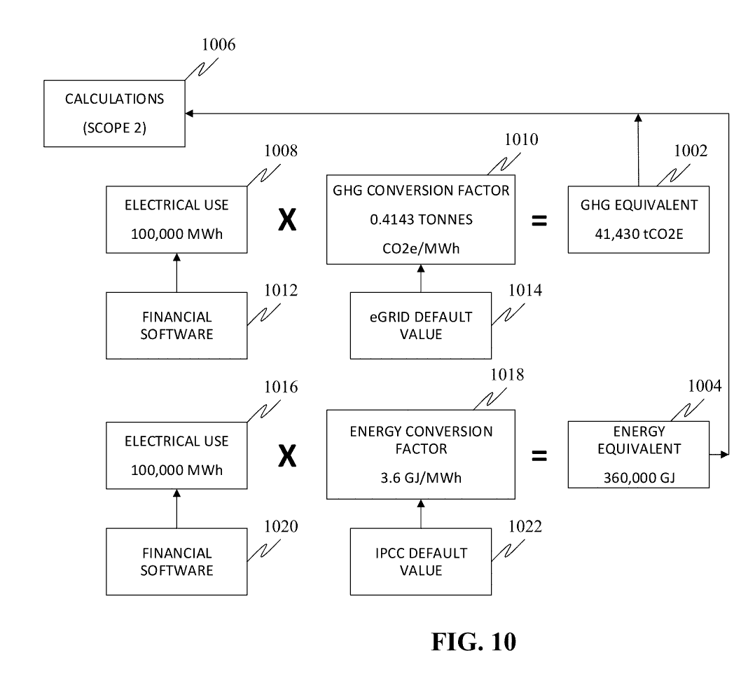

FIG. 10 is an exemplary method for obtaining calculations 1006 for the GHG emission (such as GHG equivalent 1002) and energy calculation (such as energy equivalent 1004). Further, values associated with electrical use 1008 (in MWh), which may be (for instance) provided by a financial software 1012, may be multiplied with a GHG conversion factor 1010 (in tonnes CO2e/MWh from eGRID default value 1014) in order to obtain the GHG equivalent 1002. Further, values associated with electrical use 1016 (in MWh), which may be (for instance) provided by a financial software 1020, may be multiplied with a energy conversion factor 1018 (in tonnes GJ/MWh from IPCC default value 1022) in order to obtain the energy equivalent 1004.

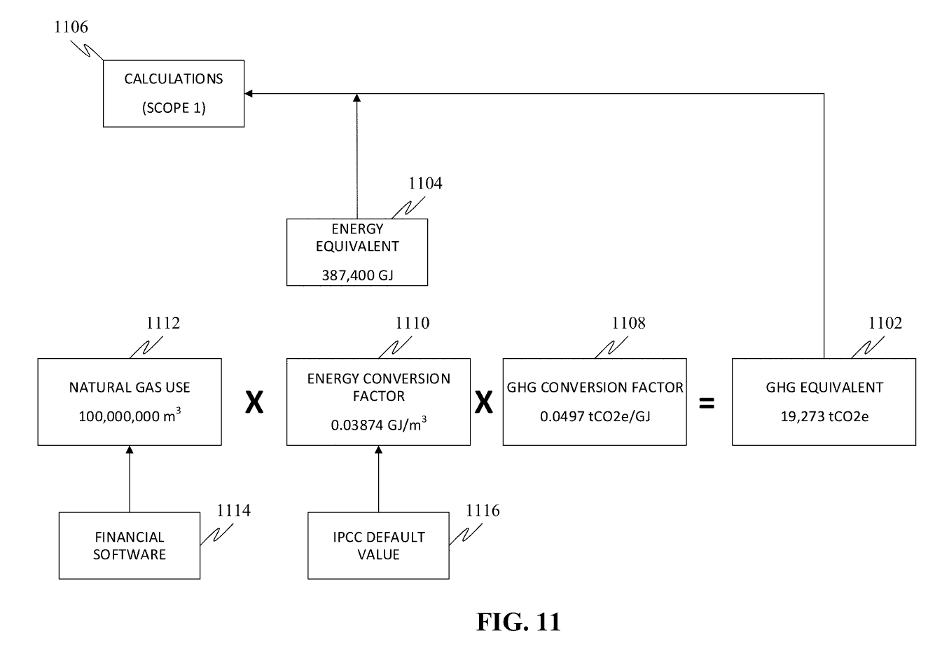

FIG. 11 is an exemplary method for obtaining calculations 1106 for the GHG emission (such as GHG equivalent 1102) and energy calculation (such as energy equivalent 1104). Further, values associated with natural gas use 1112 (in meter cube), which may be (for instance) provided by a financial software 1114, may be multiplied with a energy conversion factor 1110 (in GJ/meter cube, from IPCC default value 1116). Resultant may further be multiplied with a GHG conversion factor 1108 (for e.g. 0.0497 tCO2e/GJ) in order to obtain the GHG equivalent 1102.

Once the energy and GHG calculations are completed as shown in FIG. 10 and FIG. 11, there is typically an internal review to make sure that the numbers look correct. Some companies will also hire an assurance company as part of the internal review team to also review the numbers, but this requires additional costs, resources and time.

Furthermore, assurance companies only do a sample review and not a detailed review for each energy transaction or site. Assurance companies also often miss some of the unique nuances like what will be described for liquid fuels with storage that will impact the actual energy usage and resulting GHG emissions reported. Once the energy and GHG data has been reviewed and verified to the best of the company's ability it is then released to the various government, carbon reporting agencies, shareholders and the public.

Since there is no official universal standard or at least an easy way of identifying what assumptions or methodology the energy professional utilized in calculating their energy usage or GHG emissions, it is difficult for third parties like governments, and reporting agencies or investors and the public to properly compare the GHG emissions between companies, cities or other GHG reporters.

Accurate energy and GHG reporting and becomes even more complex for companies, cities and such that use liquid fuels (diesel, heavy fuel oil, LNG, gasoline, etc.). With liquid fuels, there is usually a storage tank infrastructure in place to store the fuel until it is needed. The energy bills from the liquid fuel suppliers that the finance department starts the whole Energy and GHG reporting process with, is based on the amount of fuel delivered to the site not what is actually consumed. Ideally, energy consumption data for reporting should come from the meter(s) on the discharge side of the fuel tanks, not the supply side.

Furthermore, Energy bills from the various energy suppliers (electricity, natural gas, etc.) also do not have the same time period or standard. For example, the electricity billing data could be from January 4th to February 4th while the natural gas billing data could be from January 25th to February 25th.

Also, some energy bills are not based on the actual consumption, but instead an estimate of what the bill could be, based on past historical consumption data. The distinction between actual and estimated consumption values are often not recorded by the finance department and so throughout the complete chain of events leading to reporting there is no way of knowing if the energy and GHG values are actual or in fact only an estimate. Carbon reporting agencies like the CDP allow companies which are in a joint venture or partnership to report based on percent ownership or 100% if the company has operational control.

Unfortunately, because of this optionally, there really is no standard and companies can report either way. For joint venture companies that decide to report 100% of the energy use and resulting GHG emissions and they optically put themselves at a great disadvantage with the investment market or governments that use the CDP or other carbon reporting services.

Unless the investment community or government agencies are able to easily identify the choice of methodology, they could easily come to an erroneous conclusion on a company's GHG emissions, climate change performance (tCO2e/$Revenue, etc.) or how one company compares against another. Finally, those who report their GHG emissions typically only do so on a yearly basis. With the changes in the regulations and marketplace, carbon reporting will need to become more frequent.

The above information helps to illustrate the many potential areas for errors, misunderstandings, uncertainty, non-transparency and non-standardization that plagues the carbon reporting industry today and why a better solution is required.

For publicly traded companies they are hesitant to provide energy use and carbon emission data to government agencies (SEC, etc.), investors, shareholders and the public as part of their quarterly and annual financial filings unless they know the information is accurate, auditable and how it will be used.

For example, if public companies disclose information that is not correct they potentially expose themselves to a government investigation, shareholder law suits, and future investor non-confidence. Share prices can also be immediately impacted. Therefore, companies are looking for an eloquent solution to their Energy and GHG reporting requirements that is fully automated, secure, accurate, transparent, efficient, expandable, cost effective and easily auditable. The purpose of this invention is to provide the systems and methodology to companies, cities and other Energy and GHG reporting entities via remote energy metering and blockchain technology so that they can confidently address these concerns and the growing complexity, legal, financial, due diligence and transparency reporting requirements.

Furthermore, the same systems, methodologies and blockchain technology described in this patent can become the major building blocks for future carbon trading systems as they help to address some of the most significant problems and issues that plague current Carbon and Renewable Energy Credit (REC) credit schemes. While fossil fuels will generate GHG emissions, renewable energy sources will generate carbon credits (negative carbon emissions), PEC's and REC's.

Blockchain technology is most widely known as the technology behind the popular cryptocurrency, Bitcoin. A blockchain or distributed ledger creates a history of data deposits, messages, or transactions in a series of blocks where each block contains a mathematical Summary, called a hash, of the previous block.

This creates a chain where any changes made to a block will change that blocks hash, which must be recomputed and stored in the next block. This changes the hash of the next block, which must also be recomputed and so on until the end of the chain. Although the hash, or mathematical summary, is simple to compute, there are rules imposed which require the value of the hash to be below a certain threshold value.

In addition, the hash is based on a special type of mathematical function that is not reversible; you cannot predict what input can be used to produce the desired output. A valid hash is found by repeatedly adjusting a changeable value in the block and recalculating the hash until it meets the validity requirements. The freely changeable value is called the nonce. The unpredictable nature of the hash considerably increases the difficulty of finding a nonce that produces a valid hash of the block. Typically, trillions of different nonces must be tried before a valid hash is found. Therefore, changing the value of previously stored data in the blockchain is computationally expensive, although not impossible.

The security of a blockchain is further increased by implementing it on a distributed network. This means a large number of users all have access to the blockchain and are all attempting to add blocks to the end of the chain by finding a nonce that produces a valid hash for a given block of data.

When two blocks are found that both claim to reference the same previous block, a fork in the chain is created. Some users in the network will attempt to find the next block on one end of the fork while other users will work from the other end of the fork. Eventually one of the forks will surpass the other in length, and the longest chain is accepted by consensus as the valid chain. Therefore, anyone who attempts to change a block must not only re-find a valid hash for each subsequent block but must do it faster than everyone else working on the currently accepted chain. Thus, after a certain number of blocks have been chained onto a particular block, it becomes prohibitively costly to try to change that block. Blockchains on a distributed network with sufficiently restrictive rules for creating valid blocks are fairly secure against unauthorized changes to the data stored in them. This makes blockchains particularly useful for recording financial transactions and for financial reporting purposes. The blockchain data may include but is not limited to a meter ID, a meter calibration certificate, date and time frames, a location, company name, company SIC code, photograph or image of readings, whether meter has been tampered with (Y or N), whether meter is energy consumption or production (C or P), loss of data period if any and why (power outage, system problem, maintenance, etc.), type of consumption data or energy meter type (electrical, diesel, natural gas, propane, coal, heavy fuel oil, etc.), consumption data units (kWh, gallons, ft3, MMBtu, tons, etc. and equivalent metric units), carbon emission Scope designation (1, 2 or 3), meter data units (kWh, gallons, ft3, MMBtu, tons and equivalent metric units) for both energy usage and production of energy, energy conversion factor used for each meter (convert energy consumption to common energy value like MWh, MMBtu, GJ, etc.)—414.3 kg CO2e/MWh, 0.03874 GJ/m3 of natural gas, reference source used for each energy consumption and equivalent GHG emissions conversion factors—2014 eGrid, 2016 IPCC, etc., GHG conversion factor used for each meter (convert energy usage to tCO2e equivalent)—49.75 kg CO2e/GJ for natural gas, assurance or audit companies' electronic signature or report validating of energy consumption (gallons, etc.), energy use (GJ, etc.) and carbon emission (tCO2e) numbers.

However, the blockchain has not been properly adapted for use in Energy, water GHG, air emissions and water quality Reporting, and an Energy, GHG and Environmental Reporting system has not yet been created which leverages the advantages of blockchain to capture all the important data, assumptions, calculations, methodologies, due diligence, verifications, etc. that are needed to provide secure, accurate and transparent energy/water usage, GHG or air emissions or water quality that can easily be audited and reported by the company or entity to the various third party key stakeholders (SEC, OSC, ESMA, CDP, EPA, Governments, Auditors and Assurance Companies, Shareholders, etc.) and they can have full access and visibility to the carbon and energy consumption and environmental (air, water) disclosures.

For example, 75% of the G20 nations have mandatory GHG reporting requirements. In the United States, if a company produces more than 25,000 tCO2e/yr they must report their GHG emissions to the EPA's Greenhouse Gas Reporting Program (GHGRP). In addition, Publicly traded companies report their energy and water usage, GHG emissions and climate related risks to organizations like CDP and the DJSI as well. These organizations were created to provide investors, banks, lending agencies, governments, regulators and insurance companies with information on potential environmental impacts from publicly traded companies.

Publicly traded companies report this information to be transparent and provide these key stakeholders with a high level of confidence about their operations, what they are doing to combat climate change and what potential climate change risks (or opportunities) they could expect in the future. While these reporting organizations have done a good job at providing this information there is still a lack of standardization and detailed due diligence that exists. As a result, the Task Force on Climate Related Financial Disclosure (TCFD) has introduced similar protocols and practices that public companies use to report their quarterly and annual financials.

The Group of 20 economies (G20) asked the Financial Standards Board (FSB) to look at how the financial sector can properly account for climate-related issues and risks.

The TCFD (headed by Michael Bloomberg) was created to develop voluntary, consistent climate-related financial risk disclosures for use by companies in providing information to investors, lenders, insurers, and other stakeholders.

The TCFD recommends that companies must disclose Scope 1, Scope 2, and, if appropriate, Scope 3 greenhouse gas (GHG) emissions, and the related risks.

The Task Force also recommends that organizations provide climate-related financial disclosures in their mainstream (i.e., public) annual financial filings and quarterly reports if material. The disclosures related to the Strategy, Metrics, and Targets recommendations are all subject to an assessment of materiality.

Although CDP and the DJSI are adopting TCFD's recommendations, most companies do not have the systems, resources or auditing processes in place to confidently provide energy and water usage and GHG emissions as part of their quarterly and annual financial filings to the public, shareholders, and regulators.

To help understand this issue, let's look at how most companies today collect, store, calculate, review and report their energy usage and GHG emissions to the CDP and DJSI, shareholders, investors and the market.

It's important to understand that GHG emissions are not provided with the power or fuel (natural gas, diesel, propane, etc.) bills and thus must be calculated by the Energy Manager using various third-party conversion factors for each Energy (fuel, power) source.

For companies that use liquid-based fossil fuels that have onsite storage the energy use and GHG reporting problem is further exasperated. The fuel bill that a company's financial department receives is usually based on the amount of liquid fuel (diesel, HFO, LNG, etc.) that a site receives not what it actually uses.

Thus, actual fuel volumes, usage periods, potential energy savings, theft and other important factors are not properly addressed.

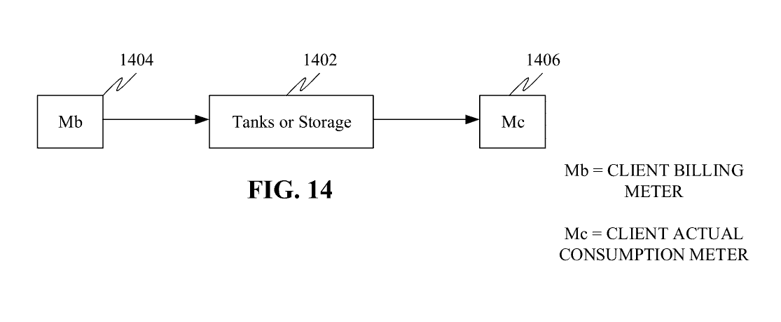

To properly address the site's actual fuel usage and resulting GHG emissions the company should really capture meter data from the output side meter (such as client actual consumption meter 1406) of storage tanks (such as storage tank 1402) and not the input side meters (amount of fuel delivered and billed), i.e. client billing meter 1404, as shown in FIG. 14.

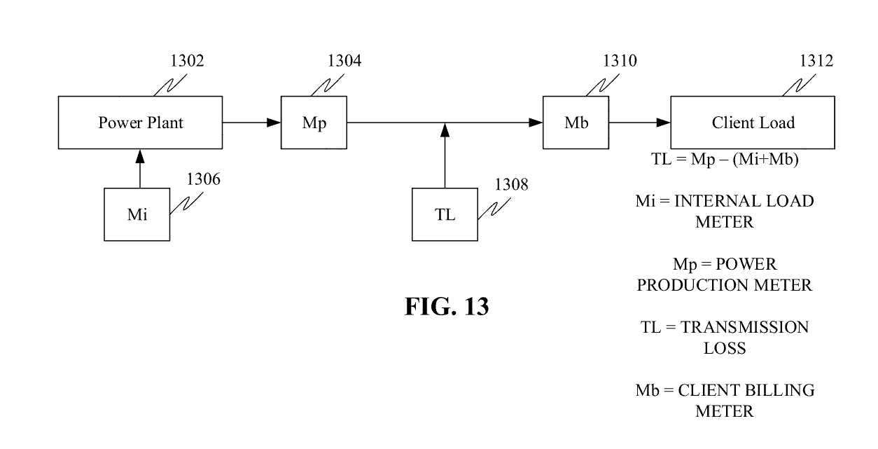

Further, as shown in FIG. 13, to properly address the site's actual electrical usage and resulting GHG emissions the company should really capture meter data from client billing meter 1310 before client load 1312, and not the internal load meter 1306 before power plant 1302 or the power production meter 1304 before transmission loss 1308.

As you can see current processes are very manual, expensive, resource heavy, fraught with many areas for potential mistakes or misunderstandings, time-consuming and difficult to audit. Furthermore, different companies use different conversion factors for Energy use and GHG emissions.

Even though many CDP reporting companies will hire an independent Assurance Company to review the data, collection and reporting methodologies, assumptions and calculations, etc. to provide a level of increased confidence in the information, the process is very time consuming and costly.

Furthermore, assurance companies only do a sample review and not a detailed review for each transaction or site. Assurance companies also often miss some of the unique nuances like what was described for liquid fuels with storage that will impact the actual energy usage and resulting GHG emissions reported. Finally, if the facility is a joint venture some companies will report just their share while others will report the full amount if they manage or control the operation.

Given these non-standards and the lack of transparency on what assumptions are being used it has been difficult for investors to properly compare the environmental performance of various companies in the same market.

Therefore, developing a better carbon reporting mechanism for these publicly traded companies would help to address their carbon reporting issues.

Carbon Blockchain Reporting.

Today's systems, resources, and methodologies are not adequate to meet the new TCFD carbon reporting requirements adopted by CDP and the DJSI.

To help C&I clients with Scope 1 (Direct GHG emissions from sources that are owned or controlled by the organization) and Scope 2 (Indirect GHG emissions typically from purchased grid electricity) and Scope 3 (supply chain, travel, etc.) emissions for Carbon reporting,

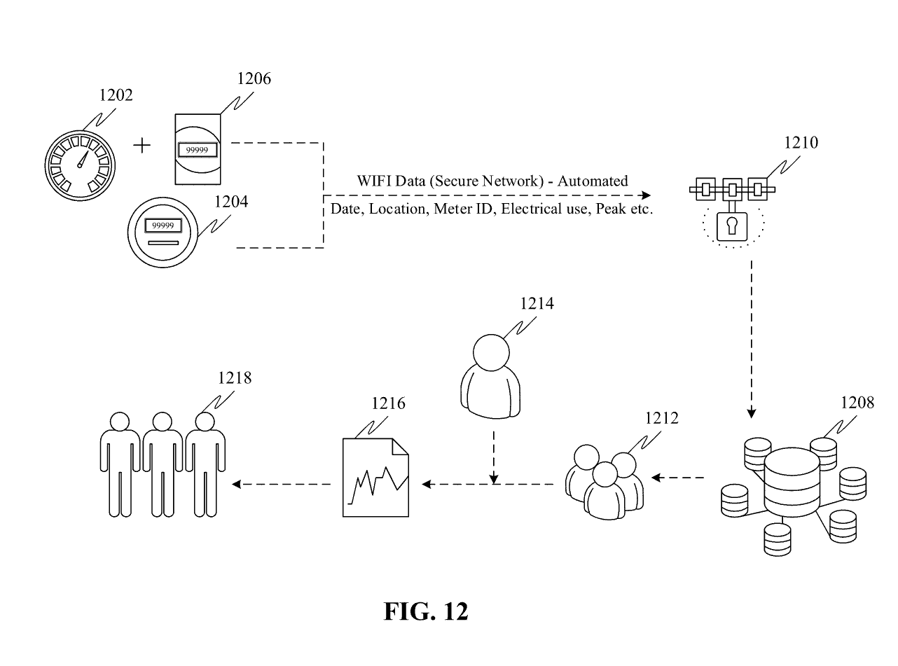

In some embodiments as illustrated in FIG. 12 a remote meter reading and the blockchain based platform may be utilized.

Every 15 to 60 minutes, energy data from a client's power, natural gas, propane, diesel, HFO, water, etc. billing meters are automatically captured by an optical or other type of automated meter reader (AMR), advanced metering infrastructure (AMI) or the Information of Things (IoT), an amperage or voltage output, flue gas analyzer, a pulse or infrared output, application programming interface (API) or script or scripting computer language (Perl, PHP, Python, JavaScript, etc) technology. If the billing meters are already digital than there are other less expensive means to collect this data directly from the Utility.

The AMR/AMI/IoT or digital meter sends the billing usage data (kWh, ft3, gallons, etc.) along with other key information like the location of the site, meter ID, type of meter (natural gas, power, water, etc.), date and time, etc.

This data is sent by encryption over a secure WIFI network to a central data warehouse. All this data (blocks) is then placed in a secure Blockchain ledger. The system then automatically takes the energy usage data and converts it to equivalent GHG emissions. The assumptions, calculation methodologies and other key information (meter calibration certification, SIC Code, etc.) are also generated and captured.

The entire process is automated from data collection right through carbon, energy and water usage reporting. Clients can now take comfort that the data is correct, secure, complete and easily auditable. Regulators (SEC, OSC, ESMA, etc.), auditors (Deloitte, etc.) and even investors could also easily review and validate these numbers (provided key codes).

Further, in some embodiments, the energy and GHG data may be collected from the utility's AMI and/or AMR meters (API, script, etc.). Further, an output signal (pulse, mA/V, etc.) may be taken from the utility's meter or submeter. Further, the remote meter reading may use OCR sensors or other IoT technologies.

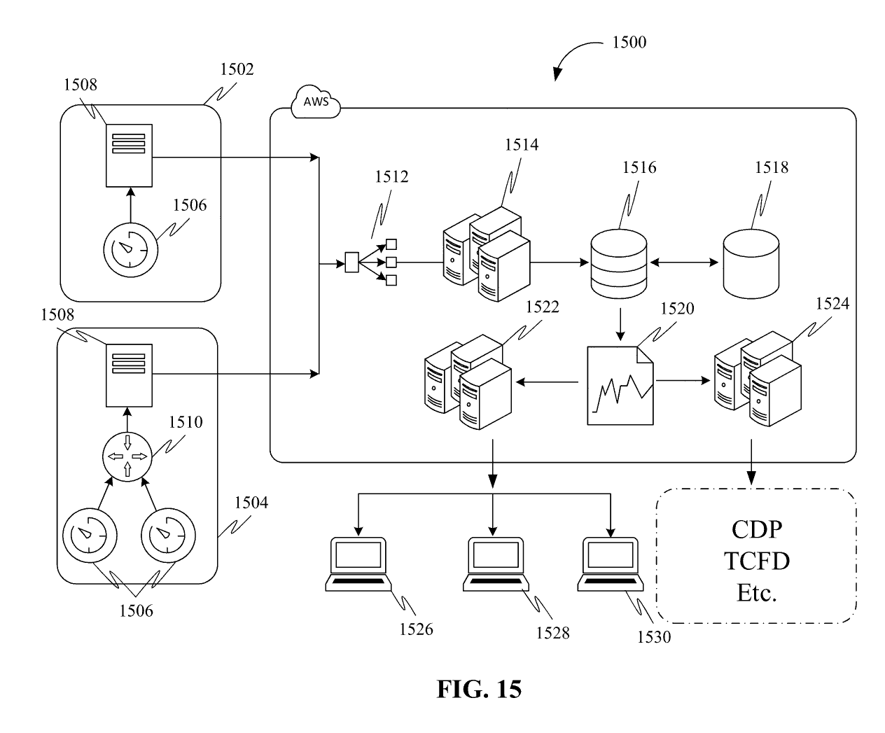

Further, in some embodiments, with reference to FIG. 15, the system may provide an option to blockchain backend that provides similar benefits in terms of data immutability, security, accuracy, transparency and auditability. Further, Optical remote real time meter reader may capture actual photo (png, jpg, gif, svg, etc. type of image files) of meter readings on a regular basis to provide a verifiable artifact that may support and validate meter reading for audit purposes. Further, in some embodiments, a photo strategy for blockchain may be included as an additional auditing feature.

Further, in some embodiments, communication from the meter to the network may be wireless, or via fixed wired connections such as power line carrier (PLC). Wireless communication options in common use may include cellular communications, Wi-Fi, wireless ad hoc networks over Wi-Fi, wireless mesh networks, low power long range wireless (LORA), ZigBee (low power, low data rate wireless), and Wi-SUN (Smart utility networks).

Further, in some embodiments, the system may provide a platform to monitor and report air emissions or water quality. For example, other mandatory or volunteered data from various environmental meters that may measure air quality (NOx, SOx, DPM, VOC's, etc.) or water quality (pH, turbidity, etc.) in real time may also be monitored and automatically reported to government, regulatory or health agencies (EPA, OSHA, EEA, etc.). Further, the system may include a sensor user interface (mA, V output), IoT or Optical meter reader (OMR) to capture data and/or photograph data from meter to network.

Further, in some embodiments, the system and the method may be used for environmental reporting other than GHG emissions.

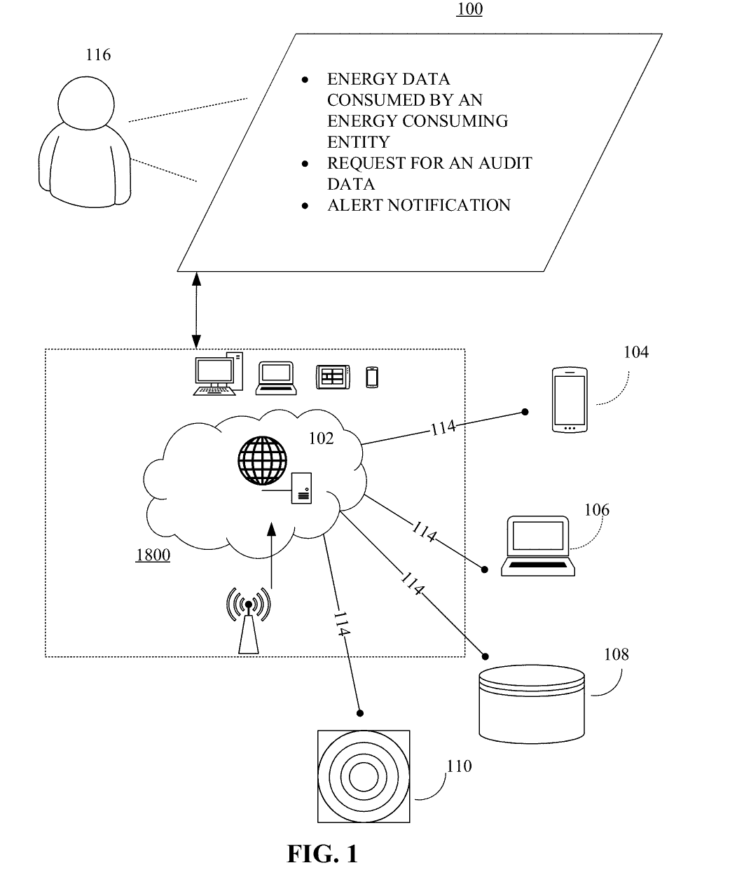

FIG. 1 is an illustration of an online platform 100 consistent with various embodiments of the present disclosure. By way of non-limiting example, the online platform 100 to facilitate provisioning of audit data related to energy consumption and GHG emissions using blockchain may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 1800.

According to some embodiments, a method to facilitate an audit data based on GHG emission by an energy consuming entity to user devices is disclosed. The online platform 100 may be provided to facilitate the audit data based on GHG emission by an energy consuming entity to one or more user devices. Greenhouse gases are those gases that absorb and emit infrared radiation in the wavelength range emitted by the earth. In order, the most abundant greenhouse gases in Earth's atmosphere are Water vapor (H2O), Carbon dioxide (CO2), Methane (CH4), Nitrous oxide (N2O), Ozone (O3), Chlorofluorocarbons (CFCs), and Hydrofluorocarbons (incl. HCFCs and HFCs) etc. CO2, methane, and nitrous oxide may be measured directly as a stack. The online platform 100 may be configured to communicate with one or more user devices such as a mobile device, a laptop, and a computer etc. The audit data based on GHG emission may be a calculated result to access how a company's data herein carbon emission may be within carbon emission range of a country.

Firstly, the online platform 100 may receive an energy data from meter such as advanced metering infrastructure (AMI), automated meter reader (AMR) using a communication device such as Bluetooth, RFID, WWI etc. The meters may capture energy data such as a client' power, natural gas, propane, HFO, water, etc. from billing meters. Sub meters may be also used for measuring energy use and GHG from subsystems and for measuring and verifying savings. Additionally, sub meters may validate accuracy, losses and may recognize missed systems.

Further, the online platform 100 may then process the energy data using a processing device such as a computer. The energy data such as the client′ power, the natural gas, the propane that may be consumed by energy consuming entities may be processed and equivalent power usage, as well as GHG emission, may be calculated. The processed data may be called the audit data.

Further, the online platform 100 may store the audit data on a storage device or a cloud database using a blockchain technology. A blockchain or distributed ledger creates a history of data deposits, messages, or transactions in a series of blocks where each block contains a mathematical summary, called a hash, of the previous block. This creates a chain where any changes made to a block will change that blocks hash, which must be recomputed and stored in the next block.

The advantages of using Blockchain includes data security, immutability, transparency and auditability. Further, the online platform 100 may receive a request to access the audit data from the one or more devices using the communication device.

Further, the online platform 100 may transmit the audit data to the one or more user devices using the communication device.

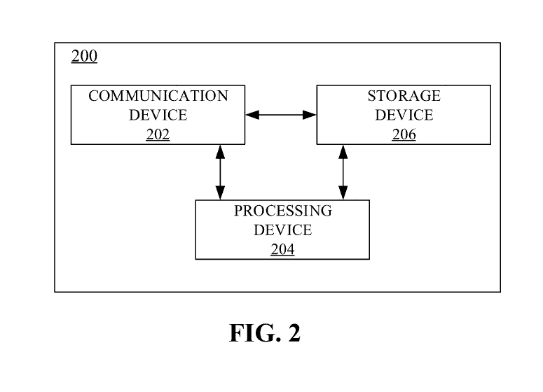

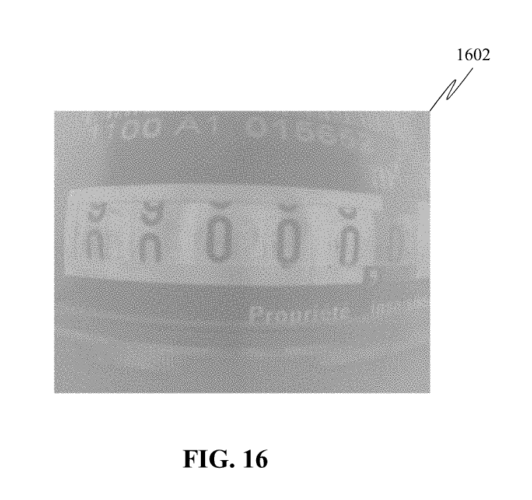

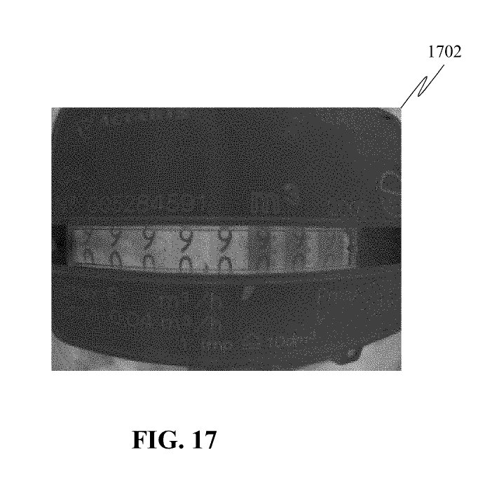

FIG. 2 is a system 200 of facilitating provisioning of audit data related to energy consumption, water consumption, water quality, greenhouse gas emissions, and air emissions using blockchain, in accordance with some embodiments. Accordingly, in the case of energy consumption and greenhouse gas (GHG) emissions, the system 200 may include a communication device 202 configured for receiving a sensory data from at least one measuring device associated with at least one energy consuming entity. Further, the at least one energy consuming entity, in an instance, may be any facility that may be consuming energy in one or more forms (e.g. electrical energy, heat energy, fuel energy, and so on). For instance, the at least one energy consuming entity may include a building, household, company/organization, factory etc. that may be consuming energy. Further, in some embodiments, the sensory data may include billing data. Further, the billing data may include at least one of an power consumption in kWh, water and fuel volume consumption in gallons (and/or in cubic meters, liters, etc.), a location associated with the at least one measuring device (for e.g. longitudinal and latitudinal coordinates), an ID associated with the at least one measuring device (for e.g. a unique identity number), a type associated with the at least one measuring device (for e.g. a power meter, a water meter, a natural gas meter, and so on), date, time and value. Further, in some embodiments, the sensory data may include data related to at least one of an air quality and air emissions. Further, the air quality and air emissions correspond to emission of at least one of carbon monoxide, carbon dioxide, methane, nitrous oxide, ozone, particulate pollution, and Sulphur dioxide. Further, in some embodiments, the sensory data may include data related to at least one of a water quality and water emissions. Further, the water quality and water emissions correspond to metrics such as at least one of Dissolved oxygen, pH, Water temperature, Turbidity, Phosphorus, Total nitrogen, and Pathogen indicators. Further, in some embodiments, the sensory data for water may include (but not limited to) consumption, re-use, recycling, reclaim, evaporation, rain water, contained in product, process, discharge, blowdown, heating, cooling, steam, treatment, storage, etc. necessary to provide a complete water balance. Further, in some embodiments, the sensory data may include a multimedia content. Further, the multimedia content may be in at least one of a textual form, a visual form, an audio form, and an audiovisual form. For instance, the multimedia content may include an image (e.g. a photo 1602 with meter readings as shown in FIG. 16, and a photo 1702 with another meter reading as shown in FIG. 17), which may be captured by a content capturing device (such as but not limited to a camera). Further, the content capturing device, in an instance, may include one or more sensors that may be configured to sense any physical, chemical and/or biological variable. For instance, the one or more sensors may include (but not limited to) camera sensors, microphones, temperature sensors, pressure sensors etc. In some embodiments, the at least one measuring device may be based on at least one of an optical technology, an advanced metering infrastructure (AMI), an automated meter reading (AMR), and an Information of Things (IoT) technology. Further, the at least one measuring device may include a billing meter. Further, the billing meter may include at least one of an analog meter and/or a digital meter. Further, in some embodiments, the at least one measuring device may include at least one of an air quality meter, and a water quality meter configured for generating one or more sensory readings. In some embodiments, the at least one energy consuming entity may include at least one electrical appliance. For instance, the at least one electrical appliance may include (but not limited to) a CNC machine, an air conditioner, electric pumps, and so on.

Further, the system 200 may include a processing device 204 configured for analyzing the sensory data.

Further, the processing device 204 may be configured for generating the audit data based on the analyzing. In some embodiments, the audit data may include at least one of an energy usage data, a carbon emission data, a water usage data, an air emissions data, and a water quality data.

Further, the system 200 may include a storage device 206 configured for storing the audit data on blockchain. Further, the audit data may be used for at least one of monitoring purposes, reporting purposes, and analytical purposes. For instance, a client may use the audit data for real time monitoring, reporting, and analytical purposes.

In some embodiments, the system 200 may further include the communication device 202 configured for receiving a request from at least one user device to access the audit data. In some embodiments, the at least one user device may correspond to at least one of an auditor, government agencies, staff, platform provider, carbon reporting agencies, shareholders, and members of general public.

Further, the communication device 202 may be configured for transmitting the audit data to the at least one user device. Further, in some embodiments, reports and/or analytics may also be transmitted to the at least one user device.

Further, the system 200 may include the storage device 206 configured for retrieving the audit data from the blockchain.

In some embodiments, the storage device 206 may be further configured for storing the sensory data on the blockchain. Accordingly, in some embodiments, the system 200 may further include the communication device 202 configured for receiving a new sensory data from the at least one measuring device after a predefined period. Further, the communication device 202 may be configured for transmitting an alert notification to at least one user device based on a tamper assessment. Further, the alert notification may include at least one of (but not limited to) an email, an SMS, a voice call, a voicemail, and an audible alert. Further, the at least one user device, in an instance, may be an IoT based device which may be operated by an organization and/or an individual that may be legally authorized to take corresponding actions. For instance, the alert notification may be transmitted to a nearby electricity board in order to notify about tampering of an electric meter (e.g. power/energy meter) by a consumer. Further, in some embodiments, the at least one user device, in an instance, may correspond to at least one of an auditor, government agencies, carbon reporting agencies, shareholders, and members of general public.

Further, the system 200 may include the processing device 204 configured for comparing the new sensory data with the sensory data to obtain the tamper assessment for the at least one measuring device. Further, the system 200 may include the storage device 206 configured for retrieving the sensory data from the blockchain.

Further, in some embodiments, the storage device may be configured for storing the audit data on an encrypted storage as an alternative to blockchain. Further, the alternative to blockchain, in an instance, may include at least one of a verifiable artifact (photo of readings, etc.), cloud provider, secure sockets layer (SSL) virtual private network (VPN) tunnel, load balancer, pre-processing server, monitoring, analytical and reporting server, and front end server with a secure portal for at least one of data monitoring purposes, reporting purposes, and analytical purposes.

Further, in some embodiments, the system 200 may provide an option to Blockchain backend. Further, in some embodiments, the system 200 may include auditing, monitoring and reporting of air emissions and water quality using lot sensors, voltage/amperage output signals, etc. with Blockchain or alternative backend. Further, in such cases, “energy” meters may not apply and may likely be air emission and water quality meters and sensors instead.

Further, in some embodiments, the system 200 may include actual GHG emission data from in stack flue gas analyzers (direct measurement) as an option to energy meters (indirect measurement).

Further, in some embodiments, the system 200 may include alternatives to new IoT sensor retrofits to gather energy data such as energy and GHG data collection from utility's AMI or AMR meters (API, Script, etc.), taking an output signal (e.g., but not limited to, pulse) from the utility's meter or submeter, Remote meter reading using OCR sensors or other technologies, Getting data from an existing Energy Management System (EMS), and/or getting data from in stack gas analyzer (e.g. optical IoT, mA/V output).

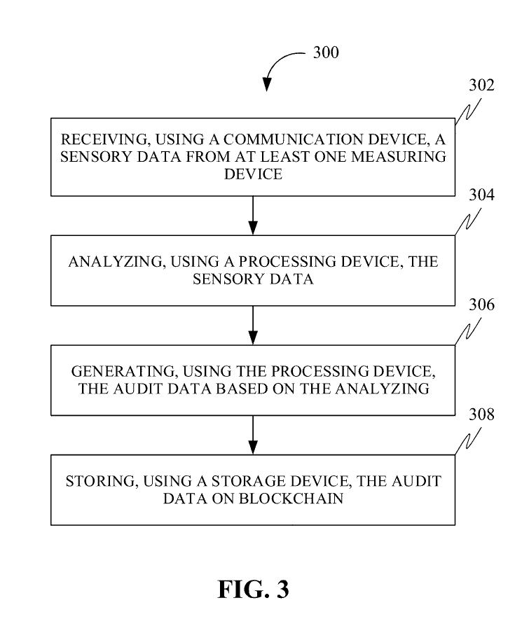

FIG. 3 is a flowchart of a method 300 of facilitating provisioning of audit data related to energy consumption, water consumption, water quality, greenhouse gas emissions, and air emissions using blockchain, in accordance with some embodiments. Accordingly, in the case of energy consumption and GHG emissions, at 302, the method 300 may include receiving, using a communication device (such as the communication device 202), a sensory data from at least one measuring device associated with at least one energy consuming entity. Further, the at least one energy consuming entity, in an instance, may be any facility that may be consuming energy in one or more forms (e.g. electrical energy, heat energy, fuel energy, and so on). For instance, the at least one energy consuming entity may include a building, household, company/organization, factory etc. that may be consuming energy. Further, in some embodiments, the sensory data may include billing data. Further, the billing data may include at least one of an power consumption in kWh, water and fuel volume consumption in gallons (and/or in cubic meters, liters, etc.), a location associated with the at least one measuring device (for e.g. longitudinal and latitudinal coordinates), an ID associated with the at least one measuring device (for e.g. a unique identity number), a type associated with the at least one measuring device (for e.g. a power meter, a water meter, a natural gas meter, and so on), date, time and value. Further, in some embodiments, the sensory data may include data related to at least one of an air quality and air emissions. Further, the air quality and air emissions correspond to emission of at least one of carbon monoxide, carbon dioxide, methane, nitrous oxide, ozone, particulate pollution, and Sulphur dioxide. Further, in some embodiments, the sensory data may include data related to at least one of a water quality and water emissions. Further, the water quality and water emissions correspond to metrics such as at least one of Dissolved oxygen, pH, Water temperature, Turbidity, Phosphorus, Total nitrogen, and Pathogen indicators. Further, in some embodiments, the sensory data for water may include (but not limited to) consumption, re-use, recycling, reclaim, evaporation, rain water, contained in product, process, discharge, blowdown, heating, cooling, steam, treatment, storage, etc. necessary to provide a complete water balance. Further, the sensory data may include a multimedia content. Further, the multimedia content may be in at least one of a textual form, visual form, audio form, and audiovisual form. In some embodiments, the at least one measuring device may be based on at least one of an optical technology, an advanced metering infrastructure (AMI), an automated meter reading (AMR), and an Information of Things (IoT) technology. Further, the at least one measuring device may include a billing meter. Further, the billing meter may include at least one of an analog meter or a digital meter. Further, in some embodiments, the at least one measuring device may include at least one of an air quality meter, and a water quality meter configured for generating one or more sensory readings. Further, in some embodiments, the at least one energy consuming entity may include at least one electrical appliance. For instance, the at least one electrical appliance may include (but not limited to) a CNC machine, an air conditioner, electric pumps, and so on.

Further, at 304, the method 300 may include analyzing, using a processing device (such as the processing device 204), the sensory data.

Further, at 306, the method 300 may include generating, using the processing device, the audit data based on the analyzing. Further, in some embodiments, the audit data may include at least one of an energy usage data, a carbon emission data, a water usage data, an air emissions data, and a water quality data.

Further, at 308, the method 300 may include storing, using a storage device (such as the storage device 206), the audit data on blockchain. Further, the audit data may be used for at least one of monitoring purposes, reporting purposes, and analytical purposes. For instance, a client may use the audit data for real time monitoring, reporting, and analytical purposes.

In further embodiments, the method 300 may include storing, using the storage device, the sensory data on the blockchain.

Further, in some embodiments, the storage device may be configured for storing the audit data on an encrypted storage as an alternative to blockchain. Further, the alternative to blockchain, in an instance, may include at least one of a verifiable artifact (photo of readings, etc.), cloud provider, secure sockets layer (SSL) virtual private network (VPN) tunnel, load balancer, pre-processing server, monitoring, analytical and reporting server, and front end server with a secure portal for at least one of data monitoring purposes, reporting purposes, and analytical purposes.

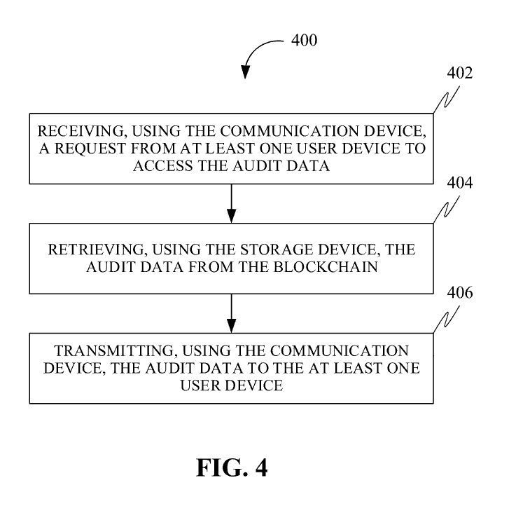

FIG. 4 is a flowchart of a method 400 to facilitate accessing the audit data, in accordance with some embodiments. Accordingly, at 402, the method 400 may include receiving, using the communication device, a request from at least one user device to access the audit data. In some embodiments, the at least one user device corresponds to at least one of an auditor, government agencies, staff, platform provider, carbon reporting agencies, shareholders, and members of general public.

Further, at 404, the method 400 may include retrieving, using the storage device, the audit data from the blockchain.

Further, at 406, the method 400 may include transmitting, using the communication device, the audit data to the at least one user device.

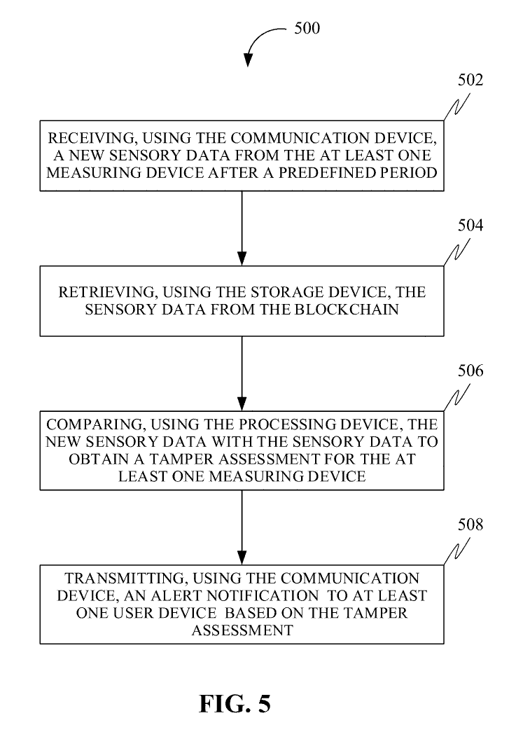

Accordingly, FIG. 5 is a flowchart of a method 500 to facilitate determining tampering associated with the at least one measuring device, in accordance with further embodiments. Further, at 502, the method 500 may include receiving, using the communication device, a new sensory data from the at least one measuring device after a predefined period.

Further, at 504, the method 500 may include retrieving, using the storage device, the sensory data from the blockchain.

Further, at 506, the method 500 may include comparing, using the processing device, the new sensory data with the sensory data to obtain a tamper assessment for the at least one measuring device.

Further, at 508, the method 500 may include transmitting, using the communication device, an alert notification to at least one user device based on the tamper assessment. Further, the alert notification may include at least one of (but not limited to) an email, an SMS, a voice call, a voicemail, and an audible alert. Further, the at least one user device, in an instance, may be an IoT based device which may be operated by an organization and/or an individual that may be legally authorized to take corresponding actions. For instance, the alert notification may be transmitted to a nearby electricity board in order to notify about tampering of an electric meter (e.g. power/energy meter) by a consumer. Further, in some embodiments, the at least one user device, in an instance, may correspond to at least one of an auditor, government agencies, carbon reporting agencies, shareholders, and members of general public.

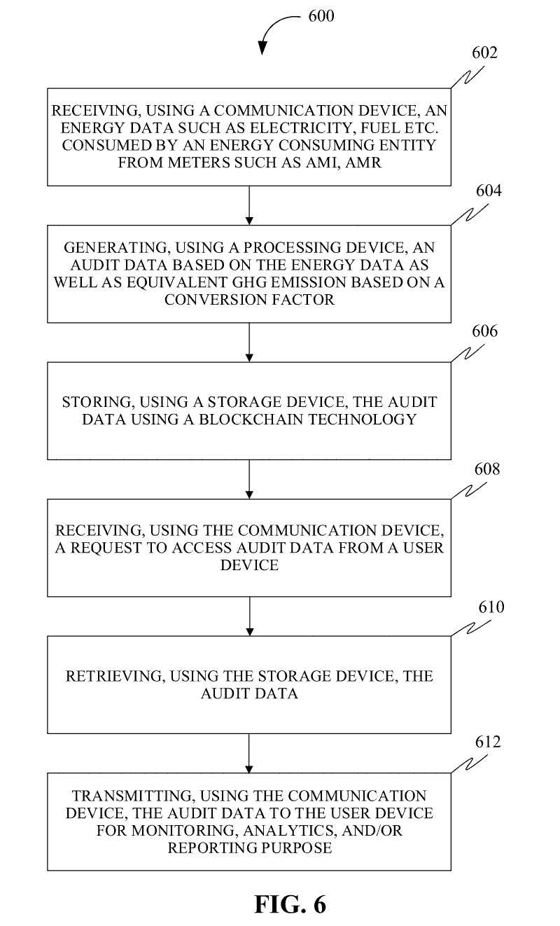

FIG. 6 is a flowchart of a method 600 to facilitate an audit data based on GHG emission by an energy consuming entity to user devices, in accordance with some embodiments. According to some embodiments, at 602, the method 600 may include a step of receiving an energy data such as electricity, fuel etc. consumed by an energy consuming entity from meters such as advanced metering infrastructure (AMI), automated meter reader (AMR) using a communication device (such as the communication device 202) such as Bluetooth, RFID, WIFI etc. The energy consuming entity in some embodiments may be a device or a machine that may consume energy to provide some work. Examples of the energy consuming entity may be a CNC machine, an air conditioner etc.

Further, at 604, the method 600 may include a step of generating an audit data based on the energy data as well as an equivalent GHG emission based on a conversion factor using a processing device (such as the processing device 204) such as a computer. The conversion factor may depend upon one or more energy source such a power, fuel etc. Energy usage, as well as GHG emission, may be calculated by the energy data and the conversion factor.

Further, at 606, the method 600 may include a step of storing the audit data on a storage device (such as the storage device 206) such as a hard drive or on an online database using a blockchain technology. In general, a blockchain or distributed ledger may create a history of data deposits, messages, or transactions in a series of blocks where each block may contain a mathematical summary, called a hash, of the previous block. This creates a chain where any changes made to a block will change that block's hash, which must be recomputed and stored in the next block.

Further, at 608, the method 600 may include a step of receiving a request to access the audit data from a user device using the communication device. For example, the user may request to access the audit data by scanning an IR code that may be present on the meter using the user device such as a mobile device.

Further, at 610, the method 600 may include a step of retrieving the audit data from the storage device.

Further, at 612, the method 600 may include a step of transmitting the audit data to the user device using the communication device.

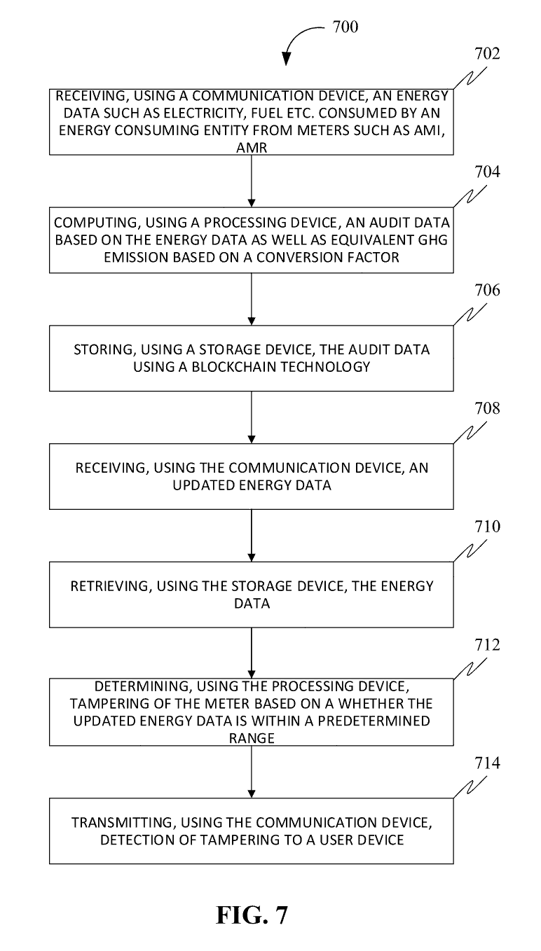

FIG. 7 is a flowchart of a method 700 to facilitate an audit data to user devices whilst monitoring tampering of a meter, in accordance with some embodiments. Firstly, at 702, the method 700 may include a step of receiving an energy data such as electricity, fuel etc. consumed by an energy consuming entity from meters such as advanced metering infrastructure (AMI), automated meter reader (AMR) using a communication device (such as the communication device 202) such as Bluetooth, RFID, WIFI etc. The energy consuming entity in some embodiments may be a device or a machine that may consume energy to provide some work. Examples of the energy consuming entity may be a CNC machine, an air conditioner etc.

Further, at 704, the method 700 may include a step of generating an audit data based on the energy data as well as an equivalent GHG emission based on a conversion factor using a processing device (such as the processing device 204) such as a computer. The conversion factor may depend upon one or more energy source such a power, fuel etc. Energy usage, as well as GHG emission, may be calculated by the energy data and the conversion factor.

Further, at 706, the method 700 may include a step of storing the audit data on a storage device (such as the storage device 206) such as a hard drive or on an online database using a blockchain technology. In general, a blockchain or distributed ledger creates a history of data deposits, messages, or transactions in a series of blocks where each block may contain a mathematical summary, called a hash, of the previous block. This creates a chain where any changes made to a block will change that block's hash, which must be recomputed and stored in the next block.

Further, at 708, the method 700 may include a step of receiving an updated energy data using the communication device. For example, the updated energy data may be an energy data that may be received after a certain amount of time.

Further, at 710, the method 700 may include a step of retrieving the energy data from the storage device.

Further, at 712, the method 700 may include a step of determining tampering of the meter based on whether the updated energy data is within a predetermined range. In some embodiment, the predetermined range may be set that may be based on an approximate usage of energy that may be calculated by taking an average of energy consumed by all the attached energy consuming entities. Accordingly, the updated energy data may lie outside the predetermined range that may indicate tampering in the meter.

Further, at 714, the method 700 may include a step of transmitting detecting of the meter to the user device using the communication device.

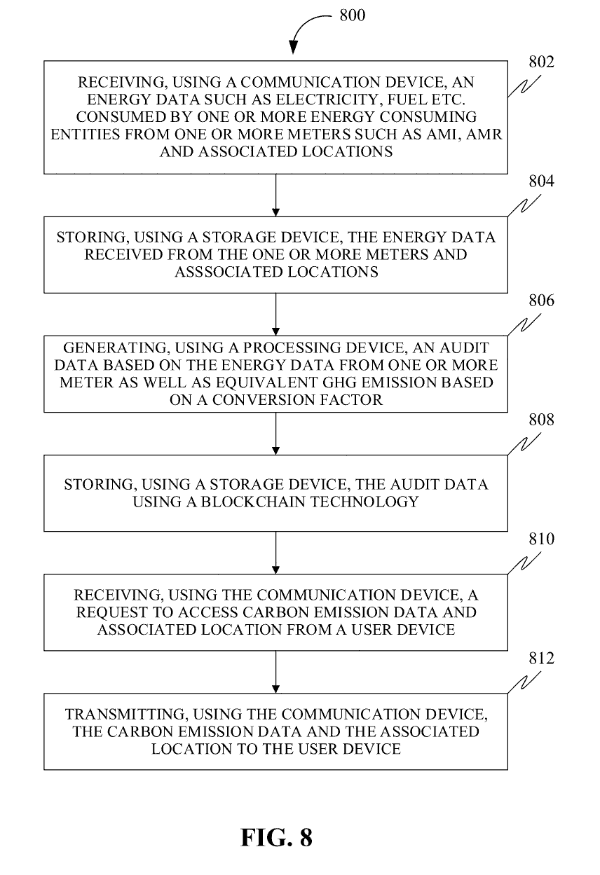

FIG. 8 is a flowchart of a method 800 to facilitate carbon emission data and associated location to user devices, in accordance with some embodiments. Firstly, at 802, the method 800 may include a step of receiving an energy data such as electricity, fuel etc. consumed by an energy consuming entity from one or more meters such as advanced metering infrastructure (AMI), automated meter reader (AMR) and associated locations of the meters using a communication device (such as the communication device 202) such as Bluetooth, RFID, WIFI etc. The energy consuming entity in some embodiments may be a device or a machine that may consume energy to provide some work. Examples of the energy consuming entity may be a CNC machine, an air conditioner etc.

Further, at 804, the method 800 may include a step of storing the energy data received from the one or more meters and associated locations on a storage device (such as the storage device 206) or on a central data warehouse using a blockchain technology. In an exemplary embodiment, the central data warehouse may receive the carbon emission data directly from power plant stacks and other sources such as flue gas analyzers. In general, a blockchain or distributed ledger creates a history of data deposits, messages, or transactions in a series of blocks where each block may contain a mathematical summary, called a hash, of the previous block. This creates a chain where any changes made to a block will change that block's hash, which must be recomputed and stored in the next block.

Further, at 806, the method 800 may include a step of generating an audit data based on the energy data from the one or more meter as well as an equivalent GHG emission based on a conversion factor using a processing device (such as the processing device 204) such as a computer. The conversion factor may depend upon one or more energy source such a power, fuel etc. Energy usage, as well as GHG emission, may be calculated by the energy data and the conversion factor. Example for calculating the conversion factor is exemplified in FIG. 10 and FIG. 11.

Further, at 808, the method 800 may include a step of storing the audit data on a storage device such as a hard drive or on an online database using the blockchain technology.

Further, at 810, the method 800 may include a step of receiving a request to access the carbon emission data and the associated location from a user device.

Further, at 812, the method 800 may include a step of transmitting the carbon emission data and the associated location to the user device using the communication device.

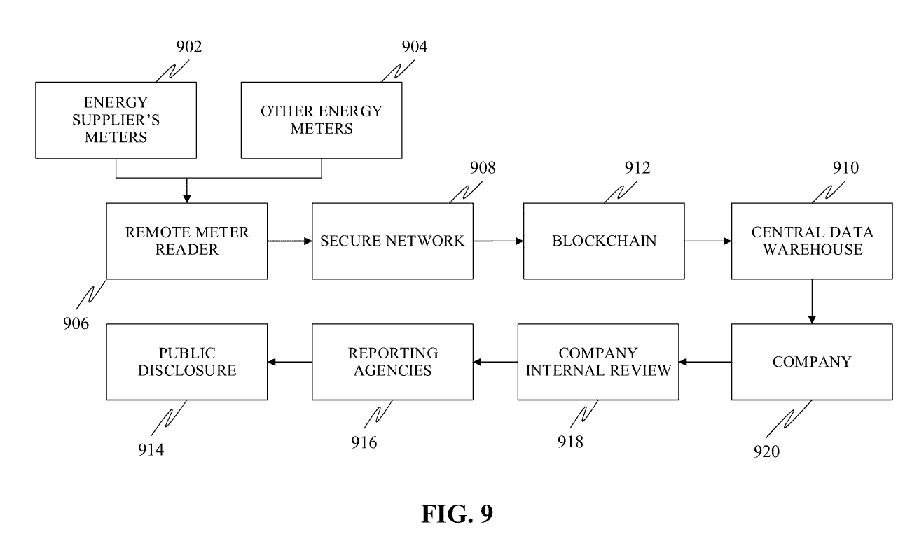

FIG. 9 is an exemplary representation of a network to facilitate an audit data for public disclosure 914 based upon energy data of energy consuming entities that may be received by meters (such as energy supplier's meters 902 and other energy meters 904) that may be attached to the energy consuming entities. Firstly, a remote meter reader 906 may receive energy data from energy supplier's meters 902 and other energy meters 904. Other energy meters 904, for example, may be flow meters that may record amount of fuel that may be dispensed in a system. Moreover, the remote meter reader 906 may receive the energy data using a communication device such as Bluetooth, RFID, and Wi-Fi etc. The energy data may be the energy that may be consumed by the energy consuming entities.

Further, the energy data received from the remote meter reader 906 may be transmitted to a blockchain 912 and a central data warehouse 910 over a secure network 908. The central data warehouse 910 may be a database that may store every information received by the remote meter reader 906 that may be placed in one or more locations. The secure network 908 such as the Wi-Fi may protect data loss over the transmission.

Further, in some embodiments, the central data warehouse 910 may calculate an equivalent energy usage and an equivalent GHG emission based on a conversion factor using a processing device such as a computer. The conversion factors are illustrated in FIG. 10 and FIG. 11. The conversion factor may be an arithmetic calculation factor that may depend upon the type of power or fuel used. The calculated data may be called an audit data.

Further, the audit data may be transmitted to a company 920 using the communication device. The company 920 may internally review (e.g. company internal review 918) the audit data.

Further, the audit data may be transmitted to reporting agencies 916. The reporting agencies may further review the audit data for authenticity. The audit data may then be disclosed publicly to investors group as mentioned in FIG. 12.

In some embodiments, with reference to FIG. 12, energy meters (such as analog meter 1202, digital meter 1204, and/or AMI/AMR/IoT based meter 1206) may be configured to read energy data and/or transmit the energy data to a central data warehouse 1208 (such as the central data warehouse 910). Further, the energy data, in an instance, may include information such as (but not limited to) date, location, meter ID, electrical use, Peak etc. Further, the central warehouse 1208, in an instance, may be configured to calculate the audit data based on the energy data taken from a carbon blockchain ledger 1210. Further, in some embodiments, the central warehouse 1208, in an instance, may be configured to store the audit data in the carbon blockchain ledger 1210. Further, clients 1212, auditors 1214, and/or reporting agencies 1216 may access the audit data through the carbon blockchain ledger 1210 in order to provide insights for other investor groups 1218.

Further, FIG. 15 is an exemplary representation of a system 1500 to facilitate provisioning of audit data related to energy and water consumption using an alternative to blockchain, in accordance with some embodiments. Accordingly, the alternative to blockchain may include at least one of a verifiable artifact (photo of readings, etc.), cloud provider, secure sockets layer (SSL) virtual private network (VPN) tunnel, load balancer, pre-processing server, monitoring, analytical and reporting server, and front end server with a secure portal for at least one of data monitoring purposes, reporting purposes, and analytical purposes.

Further, the system 1500 may include a cloud provider (such as AWS), which may be configured to pull data from IoT sensors in either from mode 1502 or mode 1504. Further, in mode 1502, wireless optical character reader 1506 may read analog or digital meters and may transmit encrypted data over cellular network to server 1508. Further, E3P's Cloud pulls data from the server 1508 at regular intervals for processing over secure SSL VPN tunnel. Further, in mode 1504, wireless optical character reader 1506 may read analog or digital meters and may transmit encrypted data to local gateway device 1510, which may then relay data securely over either encrypted cellular network, or customers internet to the server 1508. Further, E3P's Cloud pulls data from the server 1508 at regular intervals for processing over secure SSL VPN tunnel.

Further, data from meters and IoT optical sensor arrive encrypted to the Cloud Provider (AWS, etc.) into a Load Balancer 1512.

Further, a Pre-processing server 1514 may format and normalize the data and/or may place into a data base 1516 with encrypted storage 1518. Further, data types may include raw captured energy and time data from the IoT optical readers/sensors combined with original picture (png, gif, tiff, JPG, etc. image files) of meter's readout as a verifiable artifact for auditing purposes.

Further, Analytic/Reporting server 1520 may generate trends, outliers and patterns of energy usage, energy costs and GHG production on a per customer basis while generating reports for internal use and external environmental, government and financial reporting agencies (CDP, TCFD, EPA, etc.).

Further, Front-end servers 1522 may provide a secure portal for E3P (E3 Provenance 1530), customers (on a customer device 1526), auditors (on an auditor device 1528), and other third parties.

Further, integration server 1524 may format data and may provide a specific format for internal and external monitoring, reporting and analytics.

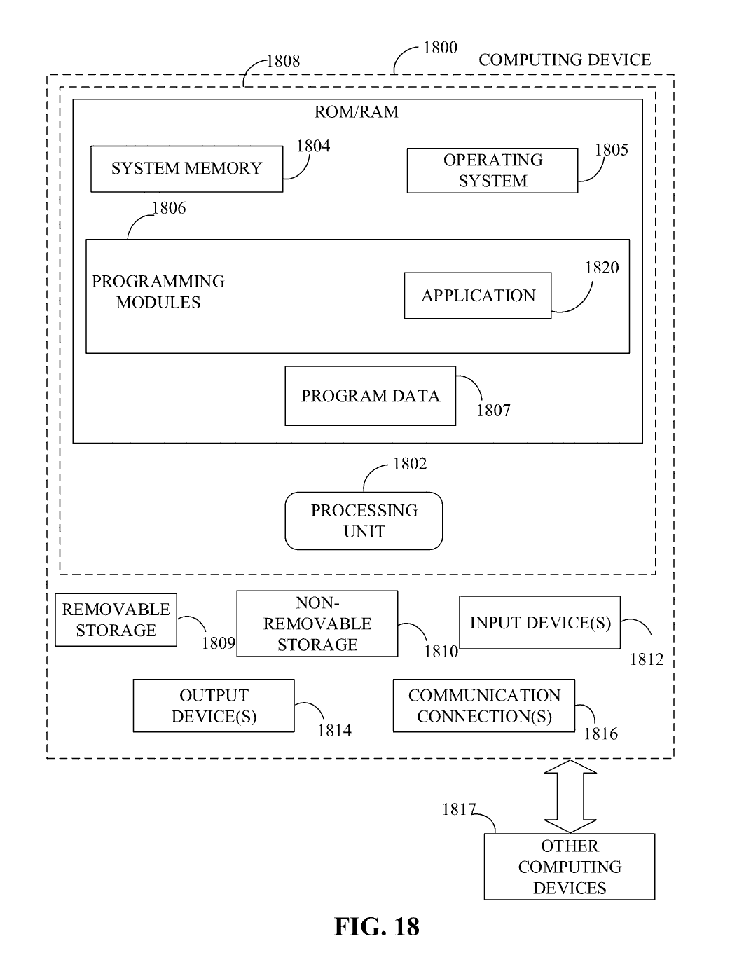

With reference to FIG. 18, a system consistent with an embodiment of the disclosure may include a computing device or cloud service, such as computing device 1800. In a basic configuration, computing device 1800 may include at least one processing unit 1802 and a system memory 1804. Depending on the configuration and type of computing device, system memory 1804 may comprise, but is not limited to, volatile (e.g. random-access memory (RAM)), non-volatile (e.g. read-only memory (ROM)), flash memory, or any combination. System memory 1804 may include operating system 1805, one or more programming modules 1806, and may include a program data 1807. Operating system 1805, for example, may be suitable for controlling computing device 1800's operation. In one embodiment, programming modules 1806 may include image-processing module, machine learning module. Furthermore, embodiments of the disclosure may be practiced in conjunction with a graphics library, other operating systems, or any other application program and is not limited to any particular application or system. This basic configuration is illustrated in FIG. 18 by those components within a dashed line 1808.

Computing device 1800 may have additional features or functionality. For example, computing device 1800 may also include additional data storage devices (removable and/or non-removable) such as, for example, magnetic disks, optical disks, or tape. Such additional storage is illustrated in FIG. 18 by a removable storage 1809 and a non-removable storage 1810. Computer storage media may include volatile and non-volatile, removable and non-removable media implemented in any method or technology for storage of information, such as computer-readable instructions, data structures, program modules, or other data. System memory 1804, removable storage 1809, and non-removable storage 1810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1800. Any such computer storage media may be part of device 1800. Computing device 1800 may also have input device(s) 1812 such as a keyboard, a mouse, a pen, a sound input device, a touch input device, a location sensor, a camera, a biometric sensor, etc. Output device(s) 1814 such as a display, speakers, a printer, etc. may also be included. The aforementioned devices are examples and others may be used.

Computing device 1800 may also contain a communication connection 1816 that may allow device 1800 to communicate with other computing devices 1818, such as over a network in a distributed computing environment, for example, an intranet or the Internet. Communication connection 1816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1804, including operating system 1805. While executing on processing unit 1802, programming modules 1806 (e.g., application 1820 such as a media player) may perform processes including, for example, one or more stages of methods, algorithms, systems, applications, servers, databases as described above. The aforementioned process is an example, and processing unit 1802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating provisioning of audit data related to energy consumption, water consumption, water quality, greenhouse gas emissions, and air emissions using blockchain, wherein the method comprising:
receiving, using a communication device, a sensory data from at least one measuring device;
analyzing, using a processing device, the sensory data;
generating, using the processing device, the audit data based on the analyzing, wherein the audit data comprises at least one of an energy usage data, a carbon emission data, a water usage data, an air emissions data, and a water quality data; and
storing, using a storage device, the audit data on blockchain, wherein the audit data is used for at least one of monitoring purposes, reporting purposes, and analytical purposes.

2. The method of claim 1, wherein the sensory data comprises billing data, wherein the billing data comprises at least one of a power consumption in kWh, water and fuel volume consumption in gallons, a location associated with the at least one measuring device, an ID associated with the at least one measuring device, a type associated with the at least one measuring device, date, time and value.

3. The method of claim 1, wherein the sensory data comprises data related to at least one of an air quality and air emissions, wherein the air quality and air emissions correspond to emission of at least one of carbon monoxide, carbon dioxide, methane, nitrous oxide, ozone, particulate pollution, and sulphur dioxide.

4. The method of claim 1, wherein the sensory data comprises data related to at least one of a water quality and water emissions, wherein the water quality and water emissions correspond to metrics such as at least one of Dissolved oxygen, pH, Water temperature, Turbidity, Phosphorus, Total nitrogen, and Pathogen indicators.

5. The method of claim 1, wherein the sensory data comprises a multimedia content, wherein the multimedia content is in at least one of a textual form, visual form, audio form, and audiovisual form.

6. The method of claim 1, wherein the at least one measuring device is based on at least one of an optical technology, an advanced metering infrastructure (AMI), an automated meter reading (AMR), and an Information of Things (IoT) technology, wherein the at least one measuring device comprises a billing meter, wherein the billing meter comprises at least one of an analog meter and a digital meter.

7. The method of claim 1, wherein the at least one measuring device comprises at least one of an air quality meter, and a water quality meter configured for generating one or more sensory readings.

8. The method of claim 1, wherein the method comprising:
receiving, using the communication device, a request from at least one user device to access the audit data, wherein the at least one user device corresponds to at least one of an auditor, government agencies, staff, platform provider, carbon reporting agencies, shareholders, and members of general public;
retrieving, using the storage device, the audit data from the blockchain; and
transmitting, using the communication device, the audit data to the at least one user device.

9. The method of claim 1, wherein the method comprising:
storing, using the storage device, the sensory data on the blockchain;
receiving, using the communication device, a new sensory data from the at least one measuring device after a predefined period;
retrieving, using the storage device, the sensory data from the blockchain;
comparing, using the processing device, the new sensory data with the sensory data to obtain a tamper assessment for the at least one measuring device; and
transmitting, using the communication device, an alert notification to at least one user device based on the tamper assessment.

10. The method of claim 1 further comprising storing, using the storage device, the audit data on an encrypted storage.

11. A system of facilitating provisioning of audit data related to energy consumption, water consumption, water quality, greenhouse gas emissions, and air emissions using blockchain, wherein the system comprising:
a communication device configured for:
receiving a sensory data from at least one measuring device;
a processing device configured for:
analyzing the sensory data; and
generating the audit data based on the analyzing, wherein the audit data comprises at least one of an energy usage data, a carbon emission data, a water usage data, an air emissions data, and a water quality data; and
a storage device configured for storing the audit data on blockchain, wherein the audit data is used for at least one of monitoring purposes, reporting purposes, and analytical purposes.

12. The system of claim 11, wherein the sensory data comprises billing data, wherein the billing data comprises at least one of a power consumption in kWh, water and fuel volume consumption in gallons, a location associated with the at least one measuring device, an ID associated with the at least one measuring device, a type associated with the at least one measuring device, date, time and value.

13. The system of claim 11, wherein the sensory data comprises data related to at least one of an air quality and air emissions, wherein the air quality and air emissions correspond to emission of at least one of carbon monoxide, carbon dioxide, methane, nitrous oxide, ozone, particulate pollution, and sulphur dioxide.

14. The system of claim 11, wherein the sensory data comprises data related to at least one of a water quality and water emissions, wherein the water quality and water emissions correspond to metrics such as at least one of Dissolved oxygen, pH, Water temperature, Turbidity, Phosphorus, Total nitrogen, and Pathogen indicators.

15. The system of claim 11, wherein the sensory data comprises a multimedia content, wherein the multimedia content is in at least one of a textual form, visual form, audio form, and audiovisual form.

16. The system of claim 11, wherein the at least one measuring device is based on at least one of an optical technology, an advanced metering infrastructure (AMI), an automated meter reading (AMR), and an Information of Things (IoT) technology, wherein the at least one measuring device comprises a billing meter, wherein the billing meter comprises at least one of an analog meter and a digital meter.

17. The system of claim 11, wherein the at least one measuring device comprises at least one of an air quality meter, and a water quality meter configured for generating one or more sensory readings.

18. The system of claim 11, wherein the system comprising:
the communication device configured for:
receiving a request from at least one user device to access the audit data, wherein the at least one user device corresponds to at least one of an auditor, government agencies, staff, platform provider, carbon reporting agencies, shareholders, and members of general public;
transmitting the audit data to the at least one user device; and the storage device configured for retrieving the audit data from the blockchain.

19. The system of claim 11, wherein the system comprising:
the storage device configured for:
storing the sensory data on the blockchain; and
retrieving the sensory data from the blockchain;
the communication device configured for:
receiving a new sensory data from the at least one measuring device after a predefined period; and
transmitting an alert notification to at least one user device based on a tamper assessment;
and the processing device configured for:
comparing the new sensory data with the sensory data to obtain the tamper assessment for the at least one measuring device.

20. The system of claim 11, wherein the storage device is further configured for storing the audit data on an encrypted storage.
